(19) United States
(12) Patent Application Publication
(10) Pub. No.: US 2020/0014035 A1
(43) Pub. Date: Jan. 9, 2020

(54) AIR ELECTRODE, METAL-AIR BATTERY, AND METHOD FOR MANUFACTURING AIR ELECTRODE

(71) Applicant: SHARP KABUSHIKI KAISHA, Osaka (JP)

(72) Inventor: KEIGO MITAMURA, Osaka (JP)

(21) Appl. No.: 16/446,302

(22) Filed: Jun. 19, 2019

(30) Foreign Application Priority Data
Jul. 3, 2018 (JP) 2018-126836

(51) Int. Cl. H01M 4/86; H01M 12/08; H01M 4/88

(52) U.S. Cl. CPC H01M 4/8657; H01M 4/8875; H01M 4/8626; H01M 12/08

(57) ABSTRACT

An air electrode, when disposed in a metal-air battery, capable of maintaining the output of the metal-air battery to a desired value or more and a method for manufacturing the air electrode are provided. The air electrode includes a porous water repellent layer and a catalyst layer being in contact with the water repellent layer. The rate of hole area in a surface of the water repellent layer is 30 area % or more and less than 45 area %. The contact angle with water of the water repellent layer is 100 degrees or more and 120 degrees or less. The method for manufacturing the air electrode includes a water repellent layer-forming step of stretching a water repellent layer-forming material to form the water repellent layer, and a press-bonding step of press-bonding the water repellent layer and the catalyst layer.

### BACKGROUND

### 1. Field

The present disclosure relates to an air electrode, a metal-air battery, and a method for manufacturing an air electrode.

### 2. Description of the Related Art

In metal-air batteries, oxygen in the air is used as the positive electrode active material of the battery. The air electrode described in Japanese Unexamined Patent Application Publication No. 2017-33650 includes a laminate composed of a gas diffusion film and a water repellent film, and a current collector. In order to enhance the adhesion between the gas diffusion film and the water repellent film, the water repellent film is prepared by electrospinning of a water repellent resin.

### SUMMARY

However, in the manufacturing of the air electrode described in Japanese Unexamined Patent Application Publication No. 2017-33650, electrospinning is necessary, leading to complication of the manufacturing process and an increase in manufacturing cost.

The present disclosure has been made in view of the above problems and provides an air electrode that can maintain the output of a metal-air battery at a desired value of more, a metal-air battery, and a method for manufacturing an air electrode, without causing complication of the manufacturing process and an increase in manufacturing cost.

The air electrode of the present disclosure includes a porous water repellent layer and a catalyst layer being in contact with the water repellent layer. The surface of the water repellent layer has a rate of hole area of 30 area % or more and less than 45 area %. The water repellent layer has a contact angle with water of 100 degrees or more and 120 degrees or less.

The metal-air battery of the present disclosure includes the above-described air electrode, a metal electrode, and an electrolyte.

The method for manufacturing an air electrode of the present disclosure manufactures the above-described air electrode. The method for manufacturing an air electrode of the present disclosure includes a water repellent layer-forming step and a press-bonding step. In the water repellent layer-forming step, a water repellent layer-forming material is stretched to form the water repellent layer. In the press-bonding step, the water repellent layer and the catalyst layer are press-bonded to each other.

### BRIEF DESCRIPTION OF THE DRAWINGS

FIG. 1 is a cross-sectional view of an air electrode according to a first embodiment of the present disclosure;

FIG. 2 is a cross-sectional view of a metal-air battery according to a third embodiment of the present disclosure;

FIG. 3 is a top view of a stretching unit of a stretching machine that is used in a method for manufacturing an air electrode according to a second embodiment of the present disclosure; and

FIG. 4 is a diagram for describing a method for evaluating the adhesion between a catalyst layer and a water repellent layer.

### DESCRIPTION OF THE EMBODIMENTS

Embodiments of the present disclosure will now be described, but the present disclosure is not limited to the following embodiments. Although the embodiments of the present disclosure will be described with reference to drawings, the drawings are merely examples, and the present disclosure is not limited to the scope shown by the drawings. In order to avoid redundancy, the same components are indicated by the same reference numerals in the drawings, and the description thereof will be omitted. Hereinafter, the volume median diameter D₅₀ of a powder (for example, catalyst particles or conductive agent) is the 50% integrating diameter bayed on volume measured by a laser diffraction/scattering method with a laser diffraction/scattering particle size distribution analyzer. The term “wt %” means “% by weight”.

### First Embodiment: Air Electrode

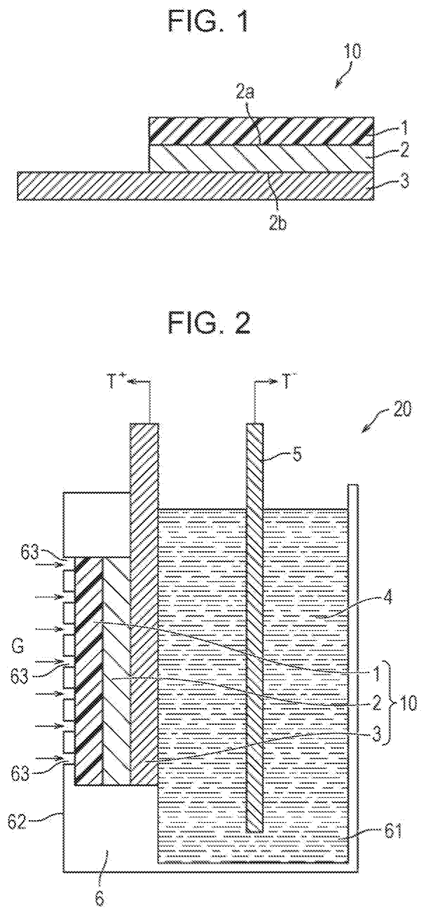

An air electrode 10 according to a first embodiment of the present disclosure will now be described with reference to FIG. 1. FIG. 1 is a cross-sectional view of the air electrode 10. The air electrode 10 includes a water repellent layer 1 and a catalyst layer 2. The water repellent layer 1 is porous. The catalyst layer 2 is in contact with the water repellent layer 1. The air electrode 10 may further include a current collector 3. The current collector 3 is in contact with the surface 2b of the catalyst layer 2. The surface 2b of the catalyst layer 2 is the surface on the opposite side of the surface 2a, which is in contact with the water repellent layer 1, of the catalyst layer 2. The catalyst layer 2 is disposed on the current collector 3. The water repellent layer 1 is disposed on the catalyst layer 2.

In order to facilitate understanding, prior to the detailed description of the air electrode 10, an outline of a metal-air battery 20 of a third embodiment will be described. FIG. 2 is a cross-sectional view of the metal-air battery 20. The metal-air battery 20 includes the air electrode 10 of the first embodiment, a metal electrode 5, an electrolyte 4 (for example, an electrolytic solution), and a casing 6. The air electrode 10 is connected to a positive electrode terminal T⁺. The metal electrode 5 is connected to a negative electrode terminal T⁻. The casing 6 accommodates the air electrode 10, the metal electrode 5, and the electrolyte 4. The casing 6 includes an electrolyte accommodating portion 61. The electrolyte accommodating portion 61 is filled with the electrolyte 4. A side surface 62 of the casing 6 is provided with a plurality of air holes 63. Air G passes through the air holes 63. The water repellent layer 1 of the air electrode 10 is disposed so as to face the side surface 62 of the casing 6. The water repellent layer 1 of the air electrode 10 is in contact with the air G through the air holes 63. The current collector 3 of the air electrode 10 is in contact with the electrolyte accommodating portion 61 of the casing 6. The current collector 3 of the air electrode 10 is in contact with the electrolyte 4 filling the electrolyte accommodating portion 61. The metal electrode 5 is disposed in the electrolyte accommodating portion 61. The metal electrode 5 is disposed in the electrolyte 4 filling the electrolyte accommodating portion 61. The electrolyte 4 containing water infiltrates into the catalyst layer 2 from the metal electrode 5 side through the current collector 3. The air G containing oxygen gas is supplied to the catalyst layer 2 from the water repellent layer 1 side. As a result, in the catalyst layer 2 of the air electrode 10, an electrode reaction (oxygen reduction reaction), specifically, a reaction represented by “O₂+2H₂O+4e⁻→4OH⁻” proceeds. Consequently, the metal-air battery 20 outputs. Thus, the air electrode 10 uses oxygen gay as an electrode active material. The outline of the metal-air battery 20 of the third embodiment has been described above with reference to FIG. 2. The air electrode 10 will now be described in detail.

### Water Repellent Layer

The water repellent layer 1 is provided in the air electrode 10 for preventing the electrolyte 4 from leaking to the outside of the metal-air battery 20 and for sending the air G to the catalyst layer 2. The water repellent layer 1 is porous. That is, water repellent layer 1 has a large number of holes. The water repellent layer 1 and the inner walls of the holes of the water repellent layer 1 have water repellency. Accordingly, water hardly enters into the holes of the water repellent layer 1. However, the air G can pass through the holes of the water repellent layer 1. The water repellent layer 1 has contrary characteristics of having a large number of holes for taking in the air G and having repellency for preventing the electrolyte 4 containing water from passing through the holes.

In the air electrode 10 of the first embodiment, the surface of the water repellent layer 1 has a rate of hole area of 30 area % or more and less than 45 area %. If the rate of hole area in the surface of the water repellent layer 1 is less than 30 area %, since the size or the number of the holes of the water repellent layer 1 is too small, the ability of sending the air G to the catalyst layer 2 through the holes of the water repellent layer 1 (hereinafter referred to as “air applying ability”) is low, and the output of the metal-air battery 20 is low from the initial stage. Incidentally, the term “initial stage” in the present specification means immediately after the production of the metal-air battery 20. In contrast, if the rate of hole area in the surface of the water repellent layer 1 is 45 area % or more, the size or the number of the holes of the water repellent layer 1 is too large. Accordingly, the electrolyte 4 enters into the holes of the water repellent layer 1 with time, the flow of the air G is gradually blocked by the electrolyte 4 in the holes. Accordingly, the air applying ability is gradually reduced, and the output of metal-air battery 20 decreases with time. From the above, the output of the metal-air battery 20 can be maintained at a desired value or more by adjusting the rate of hole area in the surface of the water repellent layer 1 to 30 area % or more and less than 45 area %.

In order to maintain the output of the metal-air battery 20 at a desired value or more, the rate of hole area in the surface of the water repellent layer 1 may be 35 area % or more and less than 45 area %. The rate of hole area in the surface of the water repellent layer 1 may be within a range between two values selected from 30 area %, 31 area %, 32 area %, 33 area %, 34 area %, 35 area %, 36 area %, 37 area %, 38 area %, 39 area %, 40 area %, 41 area %, 42 area %, 43 area %, and 44 area %.

The number-average hole diameter in the surface of the water repellent layer 1 may be 250 nm or less. Even if the surface of the water repellent layer 1 has a high rate of hole area (for example, 30 area % or more and less than 45 area, the electrolyte 4 can be suitably prevented from entering into the holes of the water repellent layer 1 by making the holes of the water repellent layer 1 small, such as a number-average hole diameter of 250 nm or less. Consequently, the output of the metal-air battery 20 can be maintained at a desired value or more.

The maximum hole diameter in the surface of the water repellent, layer 1 may be 500 nm or less. Even if the surface of the water repellent layer 1 has a high rate of hole area (for example, 30 area % or more and less than 45 area %), the electrolyte 4 can be suitably prevented from entering into the holes of the water repellent layer 1 by making the holes of the water repellent layer 1 small, such as a maximum hole diameter of 500 nm or less. Consequently, the output of the metal-air battery 20 can be maintained at a desired value or more.

The minimum hole diameter in the surface of the water repellent layer 1 may be 50 nm or more. If the minimum hole diameter is 50 nm or more, the air applying ability is enhanced, the output of the metal-air battery 20 is high from the initial stage.

The rate of hole area, the number-average hole diameter, the maximum hole diameter, and the minimum hole diameter are measured by observing the surface of the water repellent layer 1 (the surface of the water repellent layer 1 on the opposite side of the surface being in contact with the catalyst layer 2). The methods for measuring the rate of hole area, the number-average hole diameter, the maximum hole diameter, and the minimum hole diameter are those shown in examples or alternative methods thereof.

The contact angle with water of the water repellent layer 1 is 100 degrees or more and 120 degrees or less. If the contact angle with water of the water repellent layer 1 is less than 100 degrees, the water repellency of the water repellent layer 1 is too low, and the electrolyte 4 enters into the holes of the water repellent layer 1 with time. Consequently, the flow of the air G is gradually blocked by the electrolyte 4 in the holes, the air applying ability is gradually reduced, and the output of the metal-air battery 20 is gradually decreased with time. In contrast, if the contact angle with water of the water repellent layer 1 is larger than 120 degrees, the water repellency of the water repellent layer 1 is too high, and the adhesion between the water repellent layer 1 and the catalyst layer 2 is decreased. A decrease in the adhesion causes a phenomenon that the electrolyte 4 wets and spreads at the interface between the water repellent layer 1 and the catalyst layer 2 (hereinafter may be referred to as liquid leakage). The air applying ability is gradually reduced by the liquid leakage, and the output of the metal-air battery 20 is decreased with time. From the above, the output of the metal-air battery 20 can be maintained at a desired value or more by adjusting the contact angle with water of the water repellent layer 1 to 100 degrees or more and 120 degrees or less.

The upper limit of the contact degree with water of the water repellent layer 1 may be less than 120 degrees. The lower limit of the contact degree with water of the water repellent layer 1 is preferably 110 degrees or more, more preferably 112 degrees or more, further preferably 114 degrees or more, and most preferably 115 degrees or more. In addition, the contact angle with water of the water repellent layer 1 may be within a range between two values selected from 100 degrees, 102 degrees, 110 degrees, 112 degrees, 114 degrees, 115 degrees, 118 degrees, and 120 degrees.

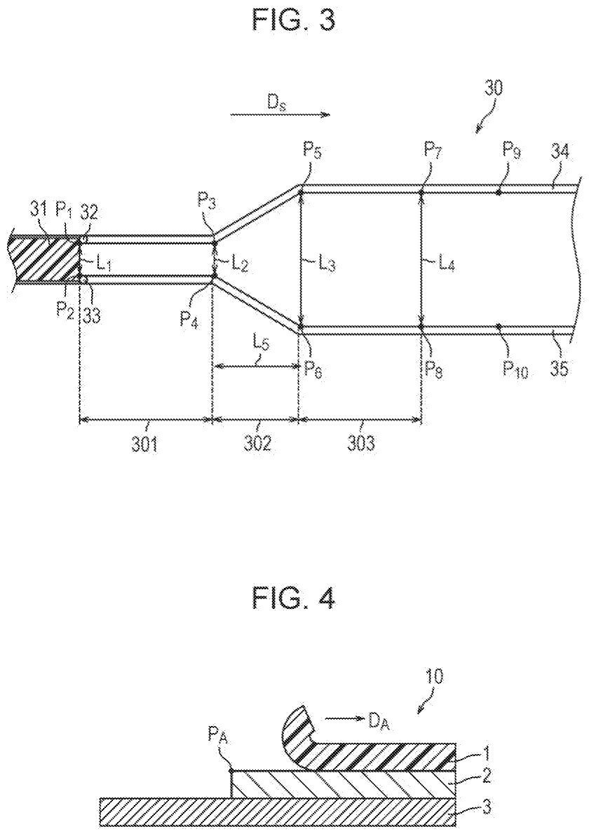

The contact angle with water of the water repellent layer 1 can be adjusted by appropriately selecting the water repellent layer-forming material 31 (see FIG. 3) having a desired contact angle. For example, a commercial product can be used as the water repellent layer-forming material 31 having a desired contact angle. Incidentally, the contact angle with water of the water repellent layer 1 does not substantially change by, for example, stretching of the water repellent layer-forming material 31 described later and press-bonding between the water repellent layer 1 and the catalyst layer 2. The method for measuring the contact angle with water of the water repellent layer 1 is the method described in examples or an alternative method thereof.

From the viewpoint of easily adjusting the contact angle with water of the water repellent layer 1 at a value within a desired range, the water repellent layer 1 preferably contains a fluororesin and more preferably contains a fluororesin or fluororesins only. The water repellent layer 1 may contain only one kind of fluororesin or may contain two or more kinds of fluororesin. Examples of the fluororesin contained in the water repellent layer 1 include polytetrafluoroethylene (hereinafter may be referred to as “PTFE”) , a tetrafluoroethylene-hexafluoropropylene copolymer (hereinafter may be referred to as “FEP”), a perfluoroalkoxy fluororesin (hereinafter may be referred to as “PFA”), and poly(vinylidene fluoride) (hereinafter may be referred to as “PVDF”). The water repellent layer 1 may contain at least one (for example, one) of PTFE, FEP, PFA, and PVDF.

The water repellent layer 1 may be a baked layer or may be an unbaked layer. The unbaked layer is prepared by air-drying a kneaded material of the water repellent layer-forming material 31, without performing baking. In order to maintain the contact degree with water of the water repellent layer 1 at a value within a desired range, the water repellent layer 1 may be an unbaked layer. The water repellent layer 1 may have a monolayer structure or have a multilayer structure consisting of two or more layers.

The water repellent layer 1 may have a thickness of 100 μm or more and 250 μm or less. It the water repellent layer 1 has a thickness of 100 μm or more. adequate strength can be provided to the water repellent layer 1. If the water repellent layer 1 has a thickness of 250 μm or less, the air G can be easily supplied to the catalyst layer 2.

### Catalyst Layer

The catalyst layer 2 can be porous. The catalyst layer 2 preferably has a thickness, for example, 100 μm or more and 2 mm or less, more preferably 500 μm or more and 1 mm or less. The catalyst layer 2 contains, for example, a binder, catalyst particles, and a conductive agent.

The binder is contained in the catalyst layer 2 for maintaining the shape of the catalyst layer 2. Examples of the binder include fluororesins. Since fluororesins have alkali resistance, a fluororesin as the binder can prevent the catalyst layer 2 from being corroded by the alkaline electrolyte 4. As a fluororesin, PTFE can be used. PTFE can bind the catalyst particles while being formed into a fiber form. In addition, PTFE has excellent water repellency and heat tolerance.

The catalyst particles have catalytic activity for oxygen reduction reaction. On the surfaces of the catalyst particles, the oxygen reduction reaction proceeds. Examples of the material of the catalyst particles include metal oxides and sliver. Examples of the metal oxide include manganese oxide (specifically, for example, MnO₂ and Mn₃O₄) and perovskite-type metal oxides. The surfaces of the catalyst particles may be covered by a conductive agent. Alternatively, the surfaces of the catalyst particles may be covered by a porous layer made of a conductive agent. If the surfaces of the catalyst particles are covered by a conductive agent, electrons can be promptly supplied to the surfaces of the catalyst particles on which the oxygen reduction reaction proceeds. The catalyst particles preferably have a volume median diameter D₅₀ of 5 μm or more and 100 μm or less, more preferably 5 μm or more and 50 μm or less. If the catalyst particles have a volume median diameter D₅₀ within such a range, the surfaces of the catalyst particles can be easily covered by a conductive agent.

The conductive agent electrically connects between the current collector 3 and the surfaces of the catalyst particles to supply electrons necessary for oxygen reduction reaction to the surfaces of the catalyst particles. The conductive agent is, for example, carbon particles having conductivity. Examples of the material of the conductive agent include carbon black, carbon fibers, carbon nanotubes, activated carbon, and graphite. The conductive agent preferably has a volume median diameter D₅₀ of 10 nm or more and 100 nm or less, more preferably 10 nm or more and 50 nm or less. If the conductive agent has a volume median diameter D₅₀ within such a range, the conductive agent can efficiently form a conductive path in the catalyst layer 2.

### Current Collector

The current collector 3 supplies electrons to the three-phase interface of the oxygen gas as a gas phase, water as a liquid phase, and the catalyst particles as a solid phase, (for example, on the surfaces of the catalyst particles). The current collector 3 has holes through which water can pass. The current collector 3 is porous. The current collector 3 may have a thickness of 100 μm or more and 600 μm or less.

Examples of the material of the current collector 3 include nickel, silver, gold, platinum, and stainless steel. The material of the current collector 3 may be a nickel-plated metal. Examples of the nickel-plated metal include nickel-plated iron and nickel-plated stainless steel. The material of the current collector 3 may be nickel or a nickel-plated metal. Since the current collector 3 made of such a material has alkali resistance, the current collector 3 can be prevented from being corroded by the alkaline electrolyte 4.

The current collector 3 may have any shape, such as a tabular structure or a net-like structure. In order to strongly adhere the catalyst layer 2 and the water repellent layer 1 via the current collector 3, the current collector 3 may have a net-like structure.

Examples of the current collector 3 having a net-like structure include metal mesh, an expanded metal, and a punched metal. Examples of the metal mesh include plain weave, twilled weave, plain Dutch weave, and twilled Dutch weave metal mesh. The current collector 3 may include plain weave metal mesh, in particular, plain weave metal mesh of 10 to 30 mesh.

The air electrode 10 of the first embodiment has been described above. According to the air electrode 10 of the first embodiment, the output of the metal-air battery 20 can be maintained at a desired value or more. In addition, since the step such as electrospinning is unnecessary, according to the air electrode 10 of the first embodiment, the output of the metal-air battery 20 can be maintained at a desired value or more while simplifying the manufacturing process and decreasing the manufacturing cost.

### Second Embodiment: Method For Manufacturing Air Electrode

The method for measuring an air electrode 10 of a second embodiment is a method for manufacturing the air electrode 10 of the first embodiment. An example of the method for manufacturing the air electrode 10 will now be described. The method for manufacturing the air electrode 10 at least includes a water repellent layer-forming step and a press-bonding step. The method for manufacturing the air electrode 10 may further include a catalyst layer-forming step as necessary.

### Catalyst Layer-Forming Step

In the catalyst layer-forming step, a powder of catalyst particles, a conductive agent, a binder, and a dispersion medium are kneaded to form a kneaded material. Subsequently, the kneaded material is rolled to form a catalyst layer 2. The catalyst layer 2 is, for example, sheet-like. Incidentally, when a commercial product is used as the catalyst layer 2, the catalyst layer-forming step may be omitted.

### Water Repellent Layer-Forming Step

In the water repellent layer-forming step, a water repellent layer-forming material 31 is stretched to form a water repellent layer 1. The water repellent layer-forming material 31 is a non-porous layer, and when it is stretched to form a water repellent layer 1, a large number of holes are formed in the water repellent layer 1. Thus, a large number of holes are formed in the water repellent layer 1 by stretching such that the rate of hole area in the surface of the water repellent layer 1 is 40 area % or more. Examples of the water repellent layer-forming material 31 include the fluororesins already mentioned as those contained the water repellent layer 1. The stretching may be uniaxial stretching or biaxial stretching. The uniaxial stretching is stretching in the width direction or the longitudinal direction of the water repellent layer 1. The biaxial stretching is stretching in the width direction and the longitudinal direction of the water repellent layer 1. The stretching is performed with, for example, a stretching machine.

A stretching method will be described by an example of uniaxially stretching the water repellent layer-forming material 31 with reference to FIG. 3. FIG. 3 shows the upper surface of the stretching unit 30 of a stretching machine. This stretching machine is used in the water repellent layer-forming step of the method for manufacturing the air electrode 10. The stretching machine includes a stretching unit 30. A water repellent layer-forming material 31 is set in the stretching unit 30. The water repellent layer-forming material 31 is, for example, sheet-like. The stretching unit 30 includes a first clip 32, a second clip 33, a first clip transport path 34, and a second clip transport path 35. The water repellent layer-forming material 31 is transported along the transport direction Dₛ. The first clip 32 pinches one end of the water repellent layer-forming material 31. The second clip 33 pinches the other end of the water repellent layer-forming material 31. The first clip 32 and the second clip 33 are respectively connected to drive units (not shown) for transporting the first, clip 32 and the second clip 33. The first clip 32 moves along the first clip transport path 34. The second clip 33 moves along the second clip transport path 35.

In the stretching unit 30, from the upstream side of the transport direction Dₛ of the water repellent layer-forming material 31, a first region 301, a second region 302 (stretching region), and a third region 303 (heat treatment region) are disposed in this order. In addition, first to tenth positions (P₁ to P₁₀) are set in the stretching unit 30. The first position P₁ is located at the upstream end of the first region 301 in the transport direction Dₛ of the water repellent layer-forming material 31 on the first clip transport path 34. The second position P₂ is located at the upstream end of the first region 301 in the transport direction Dₛ of the water repellent layer-forming material 31 on the second clip transport path 35. The third position P₃ is located at the downstream end of the first region 301 in the transport direction Dₛ of the water repellent layer-forming material 31 on the first clip transport path 34. The fourth position P₄ is located at the downstream end of the first region 301 in the transport direction Dₛ of the water repellent layer-forming material 31 on the second clip transport path 35. The fifth position P₅ is located at the downstream end of the second region 302 in the transport direction Dₛ of the water repellent layer-forming material 31 on the first clip transport path 34. The sixth position P₆ is located at the downstream end of the second region 302 in the transport direction Dₛ of the water repellent layer-forming material 31 on the second clip transport path 35. The seventh position P₇ is located at the downstream end of the third region 303 in the transport direction Dₛ of the water repellent layer-forming material 31 on the first clip transport path 34. The eighth position P₈ is located at the downstream end of the third region 303 in the transport direction Dₛ of the water repellent layer-forning material 31 on the second clip transport path 35. The ninth position P₉ is located further downstream than the third region 303 in the transport direction Dₛ of the water repellent layer-forming material 31 on the first clip transport path 34. The tenth position P₁₀ is located further downstream than the third region 303 in the transport direction Dₛ of the water repellent layer-forming material 31 on the second clip transport path 35.

In the first region 301, the first clip transport path 34 and the second clip transport path 3b are disposed to face each other in parallel. In addition, in the first region 301, the first clip transport path 34 and the second clip transport path 35 are each disposed in parallel to the transport direction Dₛ. The distance L₁ between the first position P₁ and the second position P₂ is equal to the distance L₂ between the third position P₃ and the fourth position P₄. In the second region 302 (stretching region) of the stretching unit 30, the first clip transport path 34 and the second clip transport path 35 are disposed to face each other such that the distance between the rails of the first clip transport path 34 and the second clip transport path 35 gradually increases. The distance L₃ between the fifth position P₅ and the sixth position P₆ is larger than the distance L₂ between the third position P₃ and the fourth position P₄. In the third region 303 (heat treatment region) of the stretching unit 30, the first clip transport path 34 and the second clip transport path 35 are disposed to face each other in parallel. In addition, in the third region 303, the first clip transport path 34 and the second clip transport path 35 are disposed in parallel to the transport direction Dₛ. The distance L₃ between the fifth position P₅ and the sixth position P₆ is equal to the distance L₄ between the seventh position P₇ and the eighth position P₈.

The stretching is performed by, for example, the following procedure. At the first position P₁, the first clip 32 pinches one end of the water repellent layer-forming material 31 transported along the transport direction Dₛ. At the second position P₂, the second clip 33 pinches the other end of the water repellent layer-forming material 31 transported along the transport direction In the state in which the water repellent layer-forming material 31 is pinched by the first clip 32 and the second clip 33, the first clip 32 moves from the first position P₁ to the third position P₃ along the first clip transport path 34, and the second clip 33 moves from the second position P₂ to the fourth position P₄ along the second clip transport path 35. Subsequently, in the state in which the water repellent layer-forming material 31 is pinched by the first clip 32 and the second clip 33, the first clip 32 moves from the third position P₃ to the fifth position P₅ along the first clip transport path 34, and the second clip 33 moves from the fourth position P₄ to the sixth position P₆ along the second clip transport path 35. In the second region 302 (stretching region), as the distance between the rails of the first clip transport path 34 and the second clip transport path 35 gradually increases, the water repellent layer-forming material 31 is gradually stretched in the direction (width direction) perpendicular to the transport direction Dₛ. By the stretching, a water repellent layer 1 is formed.

Subsequently, the water repellent layer 1 may be heat-treated in the third region 303 (heat treatment region) as necessary. In the case of heat-treating the water repellent layer 1, the first clip 32 moves from the fifth position P₅ to the seventh position P₇ along the first clip transport path 34 and the second clip 33 moves from the sixth position P₆ to the eighth position P₈ along the second clip transport path 35 while the water repellent layer 1 pinched by the first clip 32 and the second clip 33 being heat-treated.

However, the water repellent layer 1 need not be heat-treated. In the case of not heat-treating the water repellent layer 1, the first clip 32 moves from the fifth position P₅ to the seventh position P₇ along the first clip transport path 34 and the second clip 33 moves from the sixth position P₆ to the eighth position P₈ along the second clip transport path 35 in the state in which the water repellent layer 1 is pinched by the first clip 32 and the second clip 33.

Subsequently, in the state in which the water repellent layer 1 is pinched by the first clip 32 and the second clip 33, the first clip 32 moves from the seventh position P₇ to the ninth position P₉ along the first clip transport path 34, and the second clip 33 moves from the eighth position P₈ to the tenth position P₁₀ along the second clip transport path 35. Then, the first clip 32 releases the water repellent layer 1 at the ninth position P₉, and the second clip 33 releases the water repellent layer 1 at the tenth position P₁₀.

The rate of hole area in the surface of the water repellent layer 1 can be adjusted by changing at least one of the distance L₂ between the third position P₃ and the fourth position P₄, the distance L₃ between the fifth position P₅ and the sixth position P₆, the length L₅ of the second region 302 in the transport direction Dₛ, and the transportation speed of the water repellent layer-forming material 31. The rate of hole area in the surface of the water repellent layer 1 increases with a decrease in the distance L₂ between the third position P₃ and the fourth position P₄. The rate of hole area in the surface of the water repellent layer 1 increases with an increase in the distance L₃ between the fifth position P₅ and the sixth position P₆. The rate of hole area in the surface of the water repellent layer 1 increases with a decrease in the length L₅ of the second region 302 in the transport direction Dₛ. The rate of hole area in the surface of the water repellent layer 1 increases with an increase in the transportation speed of the water repellent layer-forming material 31.

The distance L₂ between the third position P₃ and the fourth position P₄ may be 50 mm or more and 500 mm or less. The distance in between the fifth position P₅ and the sixth position P₆ may be 100 mm or more and 1000 mm or less. The length L₅ of the second region 302 in the transport direction Dₛ may be 0.5 m or more and 3.0 m or less, preferably 0.5 m or more and 1.8 m or less. The transportation speed of the water repellent layer-forming material 31 may be 1 m/min or more and 5 m/min or less.

Before the stretching, the water repellent layer-forming material 31 may be processed into a shape to be easily stretched. For example, the water repellent layer-forming material 31 may be kneaded to prepare a kneaded material, and the kneaded material many be rolled into a sheet-like rolled material, and the sheet-like rolled material may be stretched.

### Press-Bonding Step

In the press-bonding step, the water repellent layer 1, a catalyst layer 2, and an optional current collector 3 are press-bonded. An air electrode 10 is obtained by press-bonding the water repellent layer 1, the catalyst layer 2, and the optional current collector 3. First, a laminate including a current collector 3, a catalyst layer 2 disposed on the current collector 3, and a water repellent layer 1 disposed on the catalyst layer 2 is prepared. A pressure for press bonding (hereinafter may be referred to as “pressing pressure”) is applied to the laminate in a direction perpendicular to the surface of the laminate. The rate or hole area in the surface of the water repellent layer 1 is thus decreased by applying a pressure to the water repellent layer 1 positioned on the surface of the laminate. That is, the holes of the porous water repellent layer 1 are appropriately squeezed by applying a pressure to the water repellent layer 1 to decrease the rate of hole area in the surface of the water repellent layer 1. The decrease in the rate of hole area adjusts the rate of hole area in the surface of the water repellent layer 1 to 30 area % or more and less than 45 area %.

The decreasing rate A of the rate of hole area in the surface of the water repellent layer 1 may be 20.0% or more. The decreasing rate A of the rate of hole area in the surface of the water repellent layer 1 is calculated by the following expression (1):

A=100×(A₁−A₂)/A₁ (1)

wherein, A₁ represents the rate of hole area in the surface of the water repellent layer 1 before the press-bonding step; and A₂ represents the rate of hole area in the surface of the water repellent layer 1 after the press-bonding step.

The decreasing rate A of the rate of hole area is increased with an increase in the pressing pressure. The decreasing rate A of the rate of hole area is an indicator indicating the degree of the pressing pressure. If the decreasing rate A of the rate of hole area is 20.0% or more, the pressing pressure is high, and the adhesive strength between the water repellent layer 1 and the catalyst layer 2 is increased to enhance the adhesion. Consequently, a decrease in air applying ability caused by occurrence of liquid leakage can be suitably prevented, and the output of the metal-air battery 20 can be suitably maintained at a desired value or more.

In order to increase the adhesive strength between the water repellent layer 1 and the catalyst layer 2 for preventing the output of the metal-air battery 20 from decreasing, the decreasing rate A of the rate of hole area is preferably 22.0% or more, more preferably 24.0% or more, further preferably 25.0% or more, further preferably 30.0% or more, and particularly preferably 40.0% or more. The upper limit of the decreasing rate A of the rate of hole area is not particularly restricted and is, for example, less than 50.0%. If the decreasing rate A of the rate of hole area is less than 50.0%, the holes of the water repellent layer 1 appropriately remain to suitably maintain the air applying ability.

In order to adjust the rate of hole area in the surface of the water repellent layer 1 within a desired range after the press-bonding step while increasing the adhesive strength between the water repellent layer 1 and the catalyst layer 2, the rate of hole area in the surface of the water repellent layer 1 before the press-bonding step is preferably 40 area % or more, more preferably 40 area % or more and 80 area % or less, and further preferably 40 area or more and 60 area % or less. The rate of hole area in the surface of the water repellent layer 1 after the press-bonding step corresponds to the rate of hole area in the surface of the water repellent layer 1 described in the first embodiment.

From the viewpoint of easily adjusting the decreasing rate A of the rate of hole area within a desired range, the pressing pressure is preferably 1.80 kN/cm² or more and 3.00 kN/cm² or less, more preferably 1.80 kN/cm² or more and 2.80 kN/cm² or less. The pressing time may be 0.5 minutes or more and 10 minutes or less. The method for manufacturing an air electrode 10 of the second embodiment has been described above.

### Third Embodiment: Metal-Air Battery

Next, a metal-air battery 20 of a third embodiment will be described. The outline of the metal-air battery 20 is as already described with reference to FIG. 2. The metal-air battery 20 at least includes the air electrode 10 of the first embodiment, a metal electrode 5, and an electrolyte 4. The metal-air battery 20 uses the metal electrode 5 as a negative electrode (anode) and the air electrode 10 as a positive electrode (cathode). The metal-air battery 20 is, for example, a zinc-air battery, a lithium-air battery, a sodium-air battery, a calcium-air battery, a magnesium-air battery, an aluminum-air battery, or an iron-air battery. Examples of the material for the metal electrode 5 include zinc, lithium, sodium, calcium, magnesium, aluminum, and iron. The electrolyte 4 may be an electrolytic solution, specifically, an aqueous potassium hydroxide solution. The metal-air battery 20 can be assembled by a known method. The metal-air battery 20 of the third embodiment has been described above.

### EXAMPLES

The present disclosure will now be further specifically described by examples, but the present disclosure is not limited to the scope of the examples.

Regarding air electrodes (A-1) to (A-9) and (B-1) to (B-14), producing methods, measuring methods, evaluating methods, and the results of evaluation will be described.

### Producing Method

### Production of Air Electrode (A-1)

### Catalyst Layer-forming Step

Manganese dioxide (manufactured by Chuo Denki Kogyo Co., Ltd., “CMD-K200”, 1.0 parts by weight) as a catalyst, and carbon black (1.5 parts by weight) as a conductive agent were mixed overnight with a ball mill. The ball mill used zirconia balls with a diameter of 4 mm. The resulting mixture (specifically, a mixture of manganese dioxide and carbon black), PTFE (manufactured by Daikin Industries, Ltd., “Polyflon PTFE D-210C”, PTFE dispersion, dispersion medium: water, solid content concentration: 60 wt %) as a binder, and water wore added to the container of a pressurizing kneader. The amount of the PTFE dispersion was an amount such that the content of PTFE was 25 wt % based on the weight of the total solid content in the container. The amount of the water was an amount such that the concentration of the total solid content in the container was 50 wt %. The contents in the container were kneaded with a pressurizing kneader to prepare a kneaded material. The kneaded material was molded into a sheet-like shape with a rolling mill and was dried. Consequently, a catalyst layer was prepared.

### Water Repellent Layer-Forming Step

A method for producing a water repellent layer 1 will be described with reference to FIG. 3. A PTFE powder (manufactured by Daikin Industries, Ltd., “Polyflon PTFE F-104”, 100 parts by weight) and ethanol (100 parts by weight) were kneaded to prepare a kneaded material. The kneaded material was rolled with a rolling mill (manufactured by Thank Metal Co., Ltd., “Mechanical Pressurization 1-ton Precision Roll Press”) to prepare a sheet-like rolled material. This sheet-like rolled material was used as a water repellent layer-forming material 31. The sheet-like rolled material was a non-porous film. Subsequently, the sheet-like rolled material was stretched (more specifically, uniaxially stretched) with a stretching machine (manufactured by Bruckner Maschinonbau GmbH). In the second region 302 (stretching region) of the stretching unit 30 of the stretching machine, the sheet-like rolled material was stretched in a direction perpendicular to the transport direction Dₛ of the water repellent layer-forming material 31. The stretching conditions were an inlet width (distance L₂) of 300 mm, an outlet width (distance L₃) of 800 mm, a stretching region length (length L₅ of the second region 302) of 1.0 m, and a sheet transportation speed of 3 m/min. The stretching provided a sheet-like stretched material. A porous wafer repellent layer 1 was thus prepared. The water repellent layer-forming step was performed at an ordinary temperature without performing heat treatment in the third region 303 (heat treatment region). The production of the water repellent layer 1 has been described above with reference to FIG. 3.

### Press-Bonding Step

As the current collector, nickel mesh (20 mesh) was used. The produced catalyst layer was disposed on the current collector. The produced water repellent layer was disposed on the catalyst layer. Subsequently, a press-bonding step was performed. Specifically, the water repellent layer, the catalyst layer, and the current collector were unified by applying a pressure (pressing) in a direction perpendicular to the surface of the water repellent layer to prepare an air electrode (A-1). During the application of a pressure, the water repellent layer and the catalyst layer were press-bonded. The pressing conditions were a pressing pressure as shown in Table 1, a pressing time of 2 minutes, and a pressing temperature of 25° C.

### Production of Air Electrodes (A-2) to (A-9) and (B-10) to (B-14)

Air electrodes (A-2) to (A-9) and (B-10) to (B-14) were each produced by the same method as that for producing the air electrode (A-1) except that the water repellent layer-forming material shown in Table 1 was used, the length of the stretching region for stretching in the water repellent layer-forming step was set as shown in Table 1, and the pressing pressure in the press-bonding step was set as shown in Table 1.

### Production of Air Electrodes (B-1) to (B-9)

Air electrodes (B-1) to (B-9) were each produced by the same method as that for producing the air electrode (A-1) except that the water repellent layer-forming material shown in Table 1 was used, the water repellent layer-forming material shown in Table 1 was directly used as the water repellent layer without performing the water repellent layer-forming step, and the pressing pressure in the press-bonding step was set as shown in Table 1.

TABLE 1

| | | | Water repellent layer- | | Press- |
|---|---|---|---|---|---|
| | | | forming step | | bonding |
| | Water repellent layer- | | Sheet | Stretching | step |
| Air | forming material | | transporta- | region | Pressing |
| elec- | | Trade | tion speed | length L₅ | pressure |
| trode | Material | name | [m/min] | [m] | [kN/cm²] |
| A-1 | PTFE | A | 3 | 1.0 | 2.15 |
| A-2 | PTFE | A | 3 | 1.0 | 2.15 |
| A-3 | PFA | B | 3 | 1.0 | 2.15 |
| A-4 | FEP | C | 3 | 1.0 | 2.15 |
| A-5 | PVDF | D | 3 | 1.0 | 2.15 |
| A-6 | PTFE | A | 3 | 1.0 | 1.85 |
| A-7 | PTFE | A | 3 | 1.0 | 2.80 |
| A-8 | PTFE | A | 3 | 1.5 | 2.15 |
| A-9 | PTFE | A | 3 | 1.8 | 2.15 |
| B-1 | PTFE | E | — | — | 3.15 |
| B-2 | PTFE | F | — | — | 2.85 |
| B-3 | PTFE | F | — | — | 3.15 |
| B-4 | PTFE | G | — | — | 2.15 |
| B-5 | PTFE | G | — | — | 2.85 |
| B-6 | PTFE | G | — | — | 3.15 |
| B-7 | PP | H | — | — | 2.15 |
| B-8 | PE | I | — | — | 2.15 |
| B-9 | PET | J | — | — | 2.15 |
| B-10 | PTFE | A | 3 | 1.0 | 1.65 |
| B-11 | PTFE | A | 3 | 1.0 | 1.35 |
| B-12 | PTFE | A | 3 | 1.0 | 3.15 |
| B-13 | PTFE | A | 3 | 2.0 | 2.15 |
| B-14 | PTFE | A | 3 | 2.2 | 2.45 |

The “A” in Table 1 indicates the water repellent Layer-forming material 31 (non-porous film) produced in the water repellent layer-forming step described in the above paragraph “Production of air electrode (A-1)”. Water repellent layer-forming materials 31 having four different contact angles (specifically 114 degrees, 115 degrees, 116 degrees, and 118 degrees) were prepared depending on the lots of the PTFE powder. The “B” indicates “Neoflon PFA Film AF-0100” manufactured by Daikin Industries, Ltd. The “C” indicates “Neoflon FEP Film NF-0100” manufactured by Daikin Industries, Ltd. The “D” indicates “PVDF film” manufactured by Professional Plastics, Inc. The “E” indicates “Poreflon (registered trademark) FP-022-60” manufactured by Sumitomo Electric Fine Polymer, Inc. The “F” indicates “Poreflon HP-020-30” manufactured by Sumitomo Electric Fine Polymer, Inc. The “G” indicates “Poreflon WP-020-80” manufactured by Sumitomo Electric Fine Polymer, Inc. The “H” indicates “Torayfan (registered trademark) BO” manufactured by Toray Industries, Inc. The “I” indicates “Sunmap (registered trademark) LC” manufactured by Nitto Denko Corporation. The “J” indicates “Lumirror (registered trademark)” manufactured by Toray Industries, Inc. The water repellent layer-terming materials shewn by “B” to “D” in Table 1 were merely stretched with a stretching machine without performing kneading and rolling with a rolling mill in the water repellent layer-forming step. The in Table 1 means that a commercial product, shown in the column of “Water repellent layer-forming material” was directly used as the water repellent layer without performing the water repellent layer-forming step.

### Measuring Method

Measurement of Contact Angle with Water of Water Repellent Layer

The contact angle with water of the surface of the water repellent layer prepared in the production of water repellent layer described above was measured with a dynamic contact angle meter (manufactured by First Ten Angstroms, Inc. “FTA 125”). The contact angles with water are shown in Tables 2 and 3.

### Measurement of Rate of Hole Area of Water Repellent Layer Before Press-Bonding Step

The surface of the water repellent layer before the press-bonding step was observed with a scanning electron microscope (SEM, manufactured by Hitachi High-Technologies Corporation, “Field Emission Scanning Electron Microscope S-4800”) at a magnification of 10000, and an SEM image was obtained. The SEM image was processed to calculate the area of each of a large number of holes observed in one field of view. The rate of hole area A₁ (unit: area %) in the surface of the water repellent layer before the press-bonding step was calculated by the expression: rate of hole area−100×(total area of multiple holes)/(area of one field of view). Each rate of hole area A₁ is shown in Table 3.

### Measurement of Rate of Hole Area of Water Repellent Layer After Press-Bonding Step

The surface (the surface on the opposite side to the surface being in contact with the catalyst layer) of the water repellent layer after the press-bonding step was observed with a scanning electron microscope (SEM, manufactured by Hitachi High-Technologies Corporation, “Field Emission Scanning Electron Microscope S-4800”) at a magnification of 10000, and an SEM image was obtained. The GEM image was processed to calculate the area of each of a large number of holes observed in one field of view. The rate of hole area A₂ (unit: area %) in the surface of the water repellent layer after the press-bonding step was calculated by the expression: rate of hole area−100×(total area of multiple holes)/(area of one field of view). The rate of hole area A₂ in the surface of each water repellent layer after the press-bonding step is shown in Tables 2 and 3.

In addition, the decreasing rate A of the rate of hole area was calculated by the expression (1) from the measured rate of hole area Ai in the surface of the water repellent layer before the press-bonding step and the rate of hole area A₂ in the surface of the water repellent layer after the press-bonding step. The calculated decreasing rates A of the rate of hole area are shown in Table 3.

### Method for Measuring Hole Diameter of Water Repellent Layer After Press-Bonding Step and Results of Measurement

The equivalent circle diameter of each hole was calculated from each area of a large number of holes observed in one field of view in the above-described “Measurement of rate of hole area of water repellent layer after press-bonding step”. The equivalent circle diameters of 50 holes were measured for one field of view. The equivalent circle diameters were measured in 10 fields of view. The number-average hole diameter (unit: nm) was then calculated by the expression: number-average hole diameter=(sum of measured equivalent circle diameters)/(the number of measured holes (i.e., 500 holes). The maximum value among the measured equivalent circle diameters of 500 holes was defined as the maximum hole diameter (unit: nm). In addition, the minimum value among the measured equivalent circle diameters of 500 holes was defined as the minimum hole diameter (unit: nm). The result of measurement of the air electrode (A-1) is shown as a typical example of the results of the air electrodes (A-1) to (A-9) . The number-average hole diameter of the air electrode (A-1) was 220 nm, the maximum hole diameter was 500 nm, and the minimum hole diameter was 50 nm.

### Evaluating Method and Result of Evaluation

### Evaluation of Adhesion Between Catalyst Layer and Water Repellent Layer

The adhesion between the catalyst layer and the water repellent layer was evaluated for the air electrodes (A-1) to (A-9) and (B-1) to (B-14). The method for evaluating the adhesion between the catalyst layer and the water repellent layer will be described with reference to FIG. 4. As shown in FIG. 4, the air electrode 10 included a water repellent layer 1, a catalyst layer 2, and a current collector 3. The water repellent layer 1 was peeled from the catalyst layer 2 at one end of the air electrode 10. With one end P_{A} of the catalyst layer 2 on the peeled side fixed, the end of the water repellent layer 1 was pulled in the pulling direction D_{A}, and the maximum tension (180-degree peel strength, unit: N) for complete peeling off of the water repellent layer 1 was measured. The width and the length of the sample used as the air electrode 10 for the measurement were both 55 nm. The pulling speed was 2 mm/sec. The results of measurement of the peel strength are shown in Tables 2 and 3.

### Evaluation of Electrical Characteristics

The metal-air battery 20 will now be described with reference to FIG. 2 again. First, metal-air batteries 20 as shown in FIG. 2 were produced. Each of the metal-air batteries 20 included an air electrode 10, a metal electrode 5, and an electrolyte 4. As the positive electrode, the air electrode 10 (specifically, any of the air electrodes (A-1) to (A-1)) and (B-1) to (B-14)) was used. As the metal electrode 5 serving as a negative electrode, a zinc plate was used. As the electrolyte 4, 7 M aqueous potassium

The I-V curve characteristics of the produced metal-air batteries were evaluated using a battery test system (manufactured by Kikusui Electronics Corp., “PFX2011”). Specifically, the discharge voltage (unit: V) of each metal-air battery was measured at 30 mA/cm². The discharge voltage V₀ (initial) of the metal-air battery immediately after production of the metal-air battery and the discharge voltage V₆ of the metal-air battery 6 months after production were each measured. The results of measurement of discharge voltage V₀ and discharge voltage V₆ are shown in Tables 2 and 3. Subsequently, the discharge voltage decreasing rate (unit: M was calculated by the expression: decreasing rate=100×(V₀−V₆)/V₀. The calculated discharge voltage decreasing rates are shown in Tables 2 and 3. It was demonstrated that the decrease of the discharge voltage with time becomes large with an increase in the discharge voltage decreasing rate, resulting in a decrease in the output of the metal-air battery. A metal-air battery whose discharge voltage V₆ 6 months after production was 1.00 V or more and discharge voltage decreasing rate was less than 10.0% was evaluated to have good electrical characteristics.

The “Contact angle” in Tables 2 and 3 indicates the contact angle with water of the water repellent layer. The “Rate of hole area A₂” of the column “After press-bonding” in each of Tables 2 and 3 indicates the rate of hole area in the surface of the water repellent layer after the press-bonding step. The “Rate of hole area A₁” of the column “Before press-bonding” in Table 3 indicates the rate oi hole area in the surface of the water repellent layer before the press-bonding step. The “Decreasing rate A” of the column “After press-bonding” in Table 3 indicates the decreasing rate of the rate of hole area in the surface of the water repellent layer calculated by the expression (1). The “PP”, “PE”, and “PET” in Tables 1 and 2 indicate polypropylene, polyethylene, and polyester, respectively.

TABLE 2

| | | Water repellent layer | | | | | | |
|---|---|---|---|---|---|---|---|---|
| | | | | After | | | | |
| | | | | press- | | | | |
| | | | | bonding | | | | |
| | | | | Rate of | Adhesion | Discharge voltage | | |
| | | | Contact | hole | Peel | Initial | 6 months after | |
| | Air | | angle | area A₂ | strength | V₀ | V₆ | Decreasing |
| | electrode | Material | [degree] | [area %] | [N] | [V] | [V] | rate [%] |
| Example 1 | A-1 | PTFE | 118 | 39 | 0.72 | 1.17 | 1.09 | 6.8 |
| Example 2 | A-2 | PTFE | 114 | 41 | 0.86 | 1.14 | 1.07 | 6.1 |
| Example 3 | A-3 | PEA | 112 | 43 | 0.92 | 1.16 | 1.11 | 4.3 |
| Example 4 | A-4 | FEP | 110 | 38 | 0.89 | 1.18 | 1.12 | 5.1 |
| Example 5 | A-5 | PVDF | 102 | 41 | 0.92 | 1.15 | 1.08 | 6.1 |
| Comparative | B-1 | PTFE | 125 | 22 | 0.47 | 0.97 | 0.79 | 18.6 |
| Example 1 | | | | | | | | |
| Comparative | B-2 | PTFE | 123 | 27 | 0.42 | 1.05 | 0.84 | 20.0 |
| Example 2 | | | | | | | | |
| Comparative | B-3 | PTFE | 123 | 21 | 0.58 | 0.98 | 0.88 | 10.2 |
| Example 3 | | | | | | | | |
| Comparative | B-4 | PTFE | 121 | 36 | 0.41 | 1.16 | 0.92 | 20.7 |
| Example 4 | | | | | | | | |
| Comparative | B-5 | PTFE | 121 | 28 | 0.66 | 1.07 | 0.95 | 11.2 |
| Example 5 | | | | | | | | |
| Comparative | B-6 | PTFE | 121 | 22 | 0.77 | 0.98 | 0.91 | 7.1 |
| Example 6 | | | | | | | | |
| Comparative | B-7 | PP | 94 | 38 | 0.95 | 1.19 | 1.01 | 15.1 |
| Example 7 | | | | | | | | |
| Comparative | B-8 | PE | 88 | 40 | 0.96 | 1.18 | 0.97 | 17.8 |
| Example 8 | | | | | | | | |
| Comparative | B-9 | PET | 65 | 38 | 0.98 | 1.15 | 0.76 | 33.9 |
| Example 9 | | | | | | | | |

TABLE 3

| | | Water repellent layer | | | | | | | | |
|---|---|---|---|---|---|---|---|---|---|---|
| | | | | Before | | | | | | |
| | | | | press- | After press- | | | | | |
| | | | | bonding | bonding | | | | | |
| | | | | Rate | Rate | | | | | |
| | | | | of | of | | | | | |
| | | | | hole | hole | | | | | |
| | | | | area | area | | Adhesion | Discharge voltage | | |
| | | | Contact | A₁ | A₂ | Decreasing | Peel | Initial | 6 months | Decreasing |
| | Air | | angle | [area | [area | rate | strength | V₀ | after | rate |
| | electrode | Material | [degree] | %] | %] | A [%] | [N] | [V] | V₆ [V] | [%] |
| Example 2 | A-2 | PTFE | 114 | 56 | 41 | 26.8 | 0.86 | 1.14 | 1.07 | 6.1 |
| Example 6 | A-6 | PTFE | 115 | 56 | 44 | 21.4 | 0.74 | 1.16 | 1.05 | 9.5 |
| Example 7 | A-7 | PTFE | 114 | 56 | 32 | 42.9 | 1.12 | 1.07 | 1.01 | 5.6 |
| Example 8 | A-8 | PTFE | 114 | 46 | 35 | 23.9 | 0.85 | 1.12 | 1.05 | 6.3 |
| Example 9 | A-9 | PTFE | 115 | 41 | 31 | 24.4 | 0.88 | 1.10 | 1.01 | 8.2 |
| Comparative | B-10 | PTFE | 114 | 56 | 45 | 19.6 | 0.65 | 1.15 | 1.02 | 11.3 |
| Example | | | | | | | | | | |
| 10 | | | | | | | | | | |
| Comparative | B-11 | PTFE | 116 | 56 | 47 | 16.1 | 0.54 | 1.16 | 0.91 | 21.6 |
| Example | | | | | | | | | | |
| 11 | | | | | | | | | | |
| Comparative | B-12 | PTFE | 114 | 56 | 28 | 50.0 | 1.27 | 1.05 | 0.98 | 6.7 |
| Example | | | | | | | | | | |
| 12 | | | | | | | | | | |
| Comparative | B-13 | PTFE | 114 | 37 | 28 | 24.3 | 0.84 | 1.07 | 0.91 | 15.0 |
| Example | | | | | | | | | | |
| 13 | | | | | | | | | | |
| Comparative | B-14 | PTFE | 115 | 33 | 25 | 24.2 | 0.83 | 1.01 | 0.93 | 7.9 |
| Example | | | | | | | | | | |
| 14 | | | | | | | | | | |

As shown in Tables 2 and 3, in each of the air electrodes (A-1) to (A-9), the rate of hole area in the surface of the wafer repellent layer was 30 area % or more and less than 45 area %. The contact angle with water of the water repellent layer was 100 degrees or more and 120 degrees or less. Consequently, as shown in Tables 2 and 3, in the metal-air batteries each including any of the air electrodes (A-1) to (A-1)), the discharge voltage V₆ was 1.00 V or more, and the discharge voltage decreasing rate was less than 10.0%. The metal-air batteries each including any oi the air electrodes (A-1) to (A-9) could maintain the output at a desired value or more and showed good electrical characteristics. In addition, in the air electrodes (A-1) to (A-9), the adhesion between the catalyst layer and the water repellent layer was sufficiently high for practical use.

In contrast, as shown in Table 2, in each of the air electrodes (B-1) to (B-3), (B-5), and (B-6), the rate of hole area in the surface of the water repellent layer was not higher than 30 area % or more, and the contact angle with water of the water repellent layer was not lower than 120 degrees. As shown in Table 2, in the air electrode (B-4), the contact angle with water of the water repellent layer was not lower than 120 degrees. As shown in Table 2, in each of the air electrodes (B-7) to (B-9), the contact angle with water of the water repellent layer was not higher than 100 degrees. As shown in Table 3, in each of the air electrodes (B-10) and (B-11), the rate of hole area (the rate of hole area after the press-bonding step) in the surface of the water repellent layer was not less than 45 area %. As shown in Table 3, in each of the air electrodes (B-12) to (B-14), the rate of hole area (the rate of hole area after the press-bonding step) in the surface of the water repellent layer was not higher than 30 area %. Accordingly, as shown in Tables 2 and 3, the metal-air batteries including any of the air electrodes (B-1) to (B-14) did not satisfy one of or both that the discharge voltage V₆ is 1.00 V or more and that the discharge voltage decreasing rate is less than 10.0%.

It was demonstrated from the above that when the air electrode of the present disclosure, such as the air electrodes (A-1) to (A-9), is provided to a metal-air battery, the output of the metal-air battery can be maintained at a desired value or more. In addition, it was demonstrated that the metal-air battery of the present disclosure can maintain the output at a desired value or more. Furthermore, according to the method for manufacturing an air electrode of the present disclosure, an air electrode that can maintain the output of a metal-air battery at a desired value or more can be produced.

The air electrode of the present disclosure and the air electrode manufactured by the method of the present disclosure can be used as the air electrode of a metal-air battery. The metal-air battery of the present disclosure can be used, for example, as a main power source, auxiliary power source, or charger for an electronic device, such as a hearing aid, a mobile phone, or a digital camera.

The present disclosure contains subject matter related to hat disclosed in Japanese Priority Patent Application JP 2018-126836 filed in the Japan Patent Office on Jul. 3, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An air electrode comprising:
a porous water repellent layer; and
a catalyst layer being in contact with the water repellent layer, wherein
the water repellent layer has a surface having a rate of hole area of 30 area % or more and less than 45 area %; and
the water repellent layer has a contact angle with water of 100 degrees or more and 120 degrees or less.

2. The air electrode according to claim 1, wherein
a number-average hole diameter in the surface of the water repellent layer is 250 nm or less.

3. The air electrode according to claim 1, wherein
a maximum hole diameter in the surface of the water repellent layer is 500 nm or less.

4. The air electrode according to claim 1, wherein
the water repellent layer contains at least one selected from polytetrafluoroethylene, tetrafluoroethylene-hexafluoropropylene copolymers, perfluoroalkoxy fluororesins, and poly (vinylidene fluoride).

5. The air electrode according to claim 1, further comprising:
a current collector, wherein
the current collector is in contact with a surface of the catalyst layer on the opposite side of the surface of the catalyst layer being in contact with the water repellent layer.

6. A metal-air battery comprising:
the air electrode according to claim 1;
a metal electrode; and
an electrolyte.

7. A method for manufacturing the air electrode according to claim 1, the method comprising:
stretching a water repellent layer-forming material to form a water repellent layer; and
press-bonding the water repellent layer and a catalyst layer.

8. The method for manufacturing the air electrode according to claim 7, wherein
the water repellent layer is formed so as to have a large number of holes by stretching the water repellent layer-forming material in such a manner that a rate of hole area in a surface of the water repellent layer is 40 area % or more.

9. The method for manufacturing the air electrode, wherein
a pressure is applied to the water repellent layer in the press-bonding to decrease and adjust a rate of hole area in a surface of the water repellent layer to 30 area % or more and less than 45 area %, where
a decreasing rate A of the rate of hole area in the surface of the water repellent layer is 20.0% or more when calculated by the following expression (1):
A−100×(A₁−A₂)/A₁ (1)
where, A₁ represents the rate of hole area in the surface of the water repellent layer before the press-bonding; and A₂ represents the rate of hole area in the surface of the water repellent layer after the press-bonding.
